(19) United States
(12) Patent Application Publication
(10) Pub. No.: US 2024/0326760 A1
(43) Pub. Date: Oct. 3, 2024

(54) WHEEL CHOCK APPARATUS WITH REMOVABLE HANDLE

(71) Applicant: DEREK JONES, TRAFFORD, AL (US)

(72) Inventor: DEREK JONES, TRAFFORD, AL (US)

(21) Appl. No.: 18/624,088

(22) Filed: Apr. 1, 2024

Related U.S. Application Data
(60) Provisional application No. 63/493,737, filed on Apr. 1, 2023.

(51) Int. Cl. B60T 3/00

(52) U.S. Cl. CPC B60T 3/00

(57) ABSTRACT

A wheel chock apparatus can have a chock portion and a handle portion. The chock portion can have one or more engagement members on one or more of the sidewalls of the chock portion. The handle portion can have a grip portion at the first end and a coupling portion at the second end configured to removably couple the handle portion to the chock portion. The handle portion can have an angular orientation in relation to the sidewall of the chock portion to allow a user to easily move the chock portion without having to reach under a vehicle. The engagement member can have a post member configured to interface with an aperture of a coupling portion of the handle portion of the apparatus.

### CROSS-REFERENCE

This U.S. Non-Provisional patent application claims priority to U.S. Provisional Application No. 63/493,737 filed Apr. 1, 2023, to the above-named inventor, the disclosure of which is considered part of the disclosure of this application and is hereby incorporated by reference in its entirety.

### FIELD OF THE INVENTION

The present disclosure relates generally to a wheel chock. More particularly the disclosure relates to a wheel chock having a removably couplable handle portion.

### BACKGROUND

Currently there are a number of solutions for wheel chocks. Wheel Chocks are wedges placed closely against a vehicle's wheels to prevent movement. They are used for safety in addition to setting a vehicle's brakes. Wheel chocks are often left on the ground surface near the place where they are needed and result in damage to the chocks as well as remaining in the way of vehicles as they are being moved into position. These chocks typically require an individual to repetitively bend up and down to move the chock in and out of place resulting in fatigue and physical strain that could lead to workplace injuries. This results in numerous chocks being left on the ground that end up being damaged by vehicles and rendered useless.

It would be advantageous to have an apparatus that can place chocks without bending and putting an individual to not be able to move quickly if the vehicle starts to move when removing the chock. Furthermore, it would also be advantageous to have an apparatus comprising a handle that can be removed for ergonomic purposes. Still further, it would be advantageous to have an apparatus that can be easily stored. Therefore, there currently exists a need in the market for an apparatus that has a removable handle. The invention advantageously fills the aforementioned deficiencies by providing a wheel chock with a removable handle.

### BRIEF SUMMARY OF THE INVENTION

In one aspect, the disclosure relates to a wheel chock specifically configured with a removable handle. The apparatus can be provided in an assembly that prevents bending of the mid-section while installing a wheel chock. The apparatus can eliminate the need to bend down to place and remove the chocks. Additionally, the apparatus can be stored easily when not in use by allowing a user to easily move the chock portion out of the way and store the handle portion separately or together with the chock portion.

In another aspect, the disclosure relates to a wheel chock apparatus including a chock portion and a handle portion. The chock portion can include a first surface, second surface, and a third, a first sidewall and a second sidewall. An engagement member can be coupled to the first sidewall of the chock portion. The handle portion can removably couple to the chock portion. The handle portion includes a first end and a second end, wherein the second end further includes a coupling portion, wherein the coupling portion is configured to removably couple to the engagement member on the chock portion. A second engagement member can similarly be coupled to the second sidewall.

An engagement member and coupling portion can have any suitable configuration. An engagement member can include a post member having a tip portion having a first diameter, groove portion having a second diameter, and post portion having a third diameter. The first diameter can be greater than the second diameter, and the third diameter can be greater than the first diameter. The coupling portion can include an aperture having a diameter and a second portion with a diameter, wherein the diameter of the first portion is greater than the diameter of the tip portion and less than the diameter of the post portion.

In other embodiments, the engagement member can have a top edge and a bottom edge, with an opening formed therethrough, wherein the bottom edge of the opening has a first width and the top edge of the opening has a second width. The first width can be greater than the second width. A coupling portion can have a curved member with a first width at the base of the curved member and a second width at the tip end of the curved member. The first width can be greater than the top width. The curved member can be configured to fit within the opening of the engagement member to removably couple the handle portion to the chock portion. The width of the top edge of the curved member can be less than or equal to the width of the top edge of the opening. The width of the bottom portion of the curved member can be less than or equal to the width of the bottom edge of the opening.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a front view of an exemplary embodiment of a wheel chock apparatus of the present disclosure.

FIG. 2 is a rear view of an exemplary embodiment of a wheel chock apparatus of the present disclosure.

FIG. 3 is a side view of an exemplary embodiment of a wheel chock apparatus of the present disclosure.

FIG. 4 is a top view of an exemplary embodiment of a wheel chock apparatus of the present disclosure.

FIG. 5 is a front perspective view of an exemplary embodiment of a wheel chock apparatus of the present disclosure.

FIG. 6A is an enlarged front view of an exemplary embodiment of a wheel chock apparatus of the present disclosure.

FIG. 6B is an enlarged side perspective view of an exemplary embodiment of a wheel chock apparatus of the present disclosure with the handle portion detached.

FIG. 6C is an enlarged side perspective view of an exemplary embodiment of a wheel chock apparatus of the present disclosure with the handle portion coupled to the chock portion.

FIG. 6D is an illustration of an exemplary embodiment of a wheel chock apparatus of the present disclosure interfacing with a wheel.

FIG. 7 is a front view of an exemplary embodiment of a wheel chock apparatus of the present disclosure.

FIG. 8 is a front perspective view of an exemplary embodiment of a wheel chock apparatus of the present disclosure.

FIG. 9 is a bottom view of an exemplary embodiment of a wheel chock apparatus of the present disclosure.

FIG. 10A is a side perspective view of an exemplary embodiment of a wheel chock apparatus of the present disclosure with the handle portion detached.

FIG. 10B is an enlarged side perspective view of an exemplary embodiment of a wheel chock apparatus of the present disclosure with the handle portion coupled to the wheel chock portion.

FIG. 11A is a front view of an exemplary embodiment of a wheel chock apparatus of the present disclosure with a telescoping handle portion in an extended position.

FIG. 11B is a front view of an exemplary embodiment of a wheel chock apparatus of the present disclosure with a telescoping handle portion in a retracted position.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” or “exemplary embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

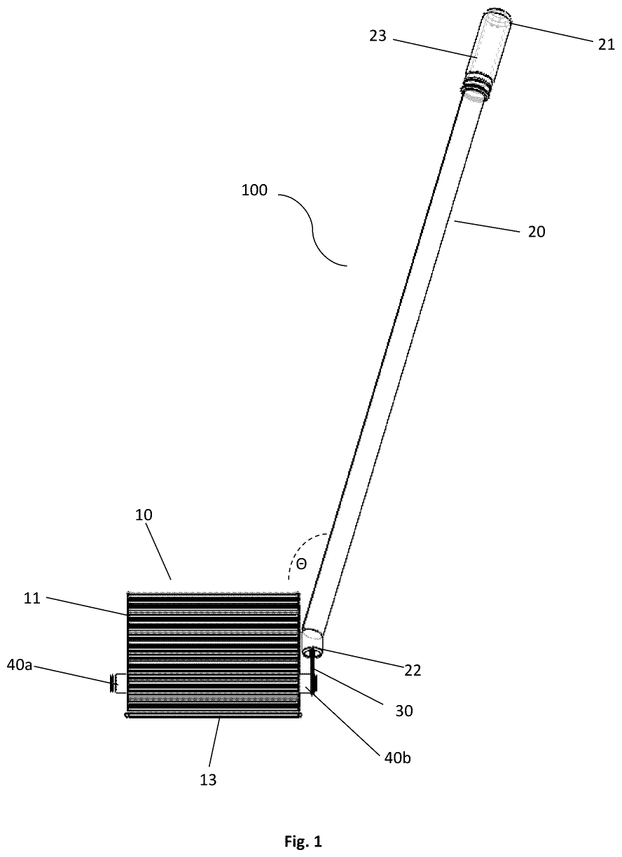

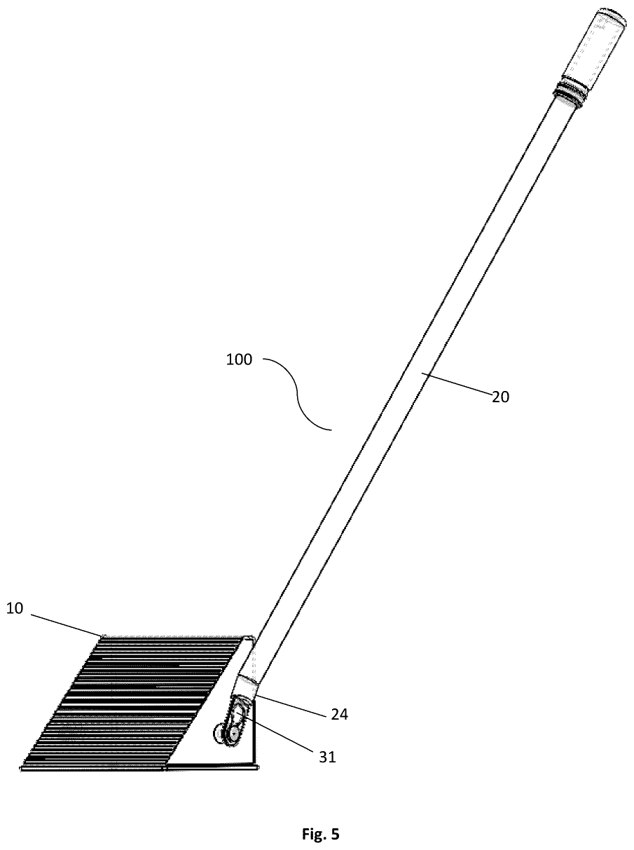

The apparatus of the present disclosure c can most generally be described as a wheel chock apparatus. As shown in FIGS. 1-6, some exemplary embodiments of the present disclosure can include a wheel chock portion 10 and a handle portion 20. The handle portion 20 can be removably couplable to the wheel chock portion 10. The handle portion 20 can have a first end 21 and a second end 22 that can generally form a length of the handle portion 20. A grip 23 can be incorporated into or coupled to the first end 21 of the handle portion 20. The grip 23 can have a texture or tackiness to provide a better interface for a user when manipulating the handle portion 20. Additionally, in some exemplary embodiments, the grip 23 can be comprised of foam for a comfortable grip by the user.

A wheel chock apparatus 100 of the present disclosure can be comprised in a structure and materials that can be considered durable and easy to clean. In some preferred embodiments, a chock portion 10 can generally be configured in a wedge or triangular body configuration to be easily wedged against a tire surface to help prevent the movement of a wheel when in a stationary position. The chock portion 10 can be made of any suitable material, including but not limited to a polymer, durable rubber, plastic, wood, metal, allow, or other suitable material.

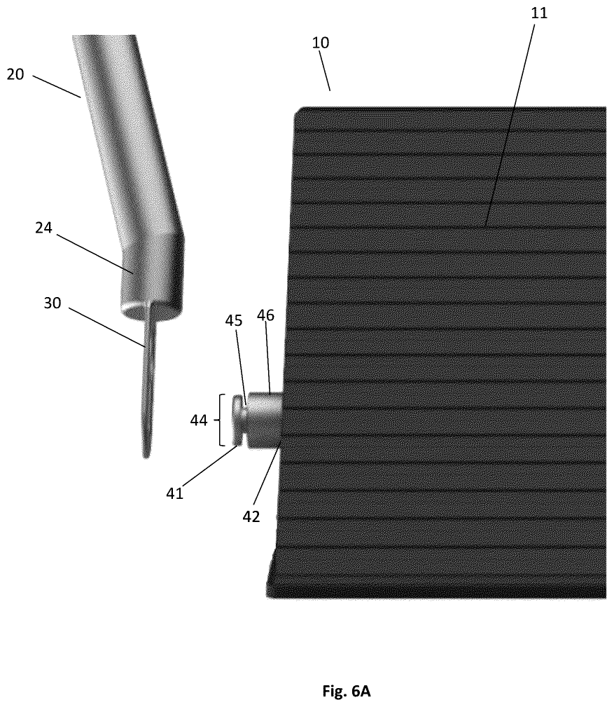

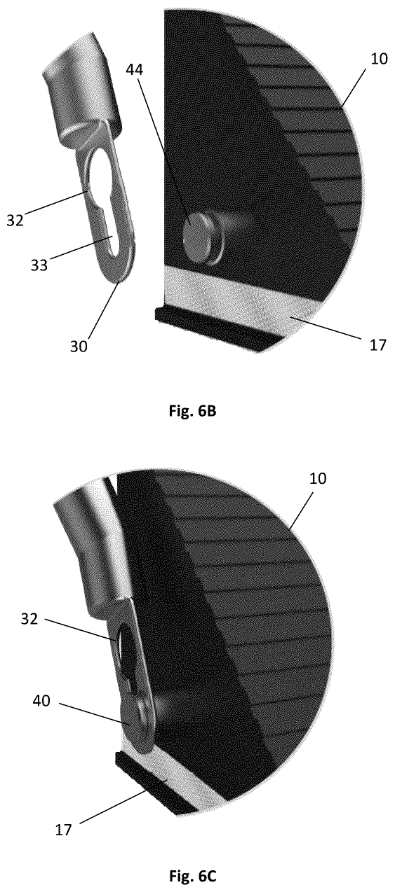

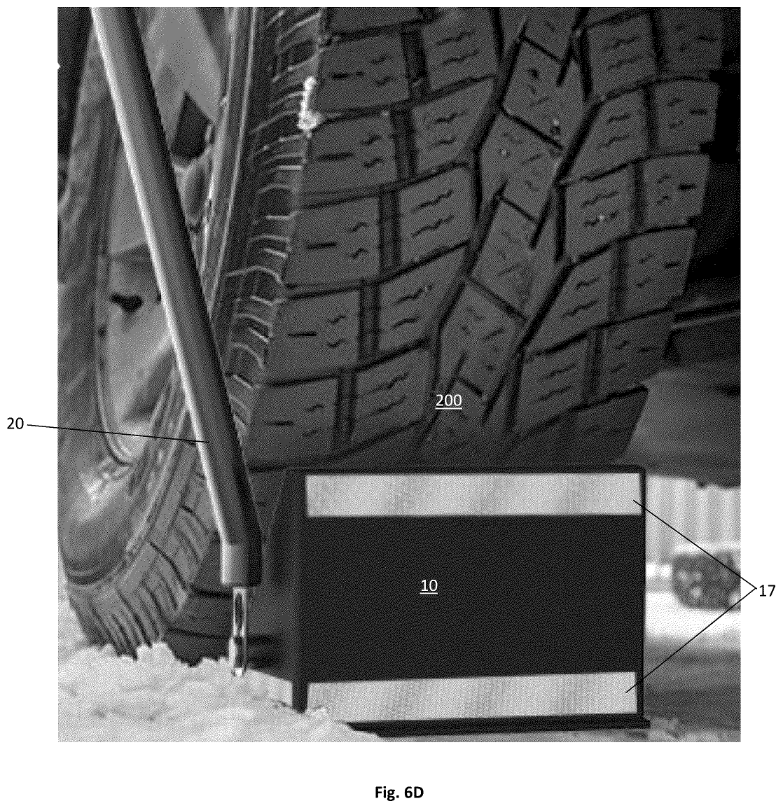

In some exemplary embodiments, the chock portion 10 can have a first surface 11, a second surface 12, and a third surface 13. The first surface 11 and second surface 12 can generally oppose one another and the third surface 13 can be bottom surface that can contact a ground surface. The bottom surface 13 can have a texture or pattern to better interface the ground and generate more friction with the ground to maintain the chock portion 10 in position. The first surface 11 and second surface 12 can optionally have a textured or grooved surface for contacting the surface of a wheel or tire 200 as shown in FIG. 6D.

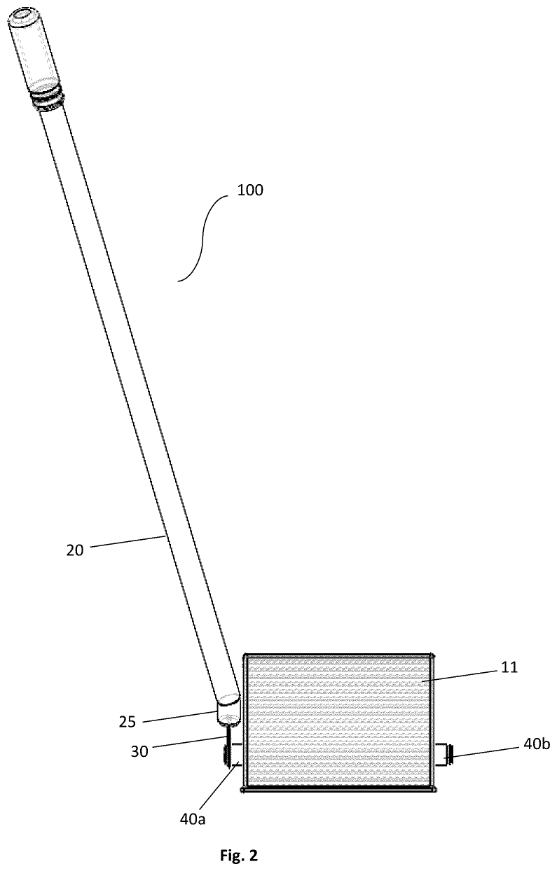

As shown in FIG. 2, a first sidewall 14 can have a first engagement member 40a and a second sidewall can have a second engagement member 40b. The engagement members 40 can allow for the handle portion 20 to removably engage the wheel chock portion 10. Embodiments having an engagement member 40 on each sidewall 14,15 can allow a user to engage the wheel chock portion 10 on both sides for more flexibility in maneuvering and moving the wheel chock portion 10. A coupling member 30 can be formed or coupled to the second end 22 of the handle portion 20. The coupling member 30 can take any suitable configuration to removably couple to the one or more engagement members 40.

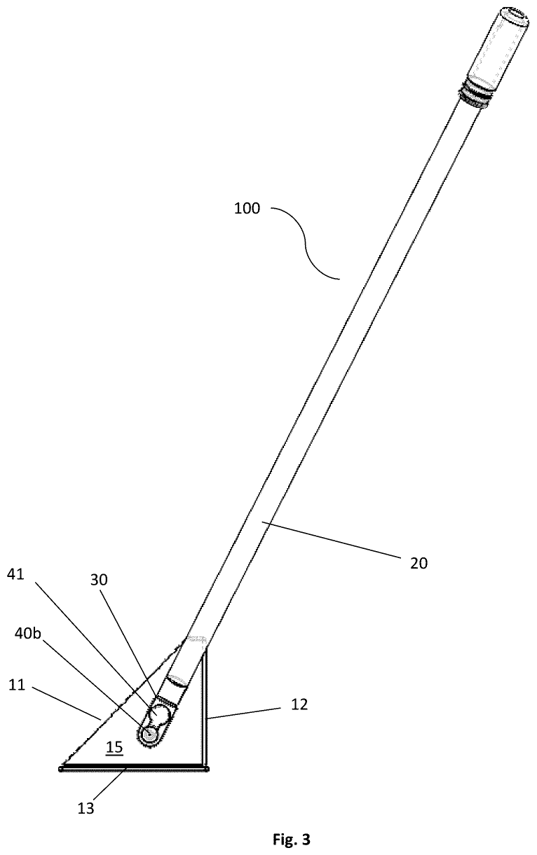

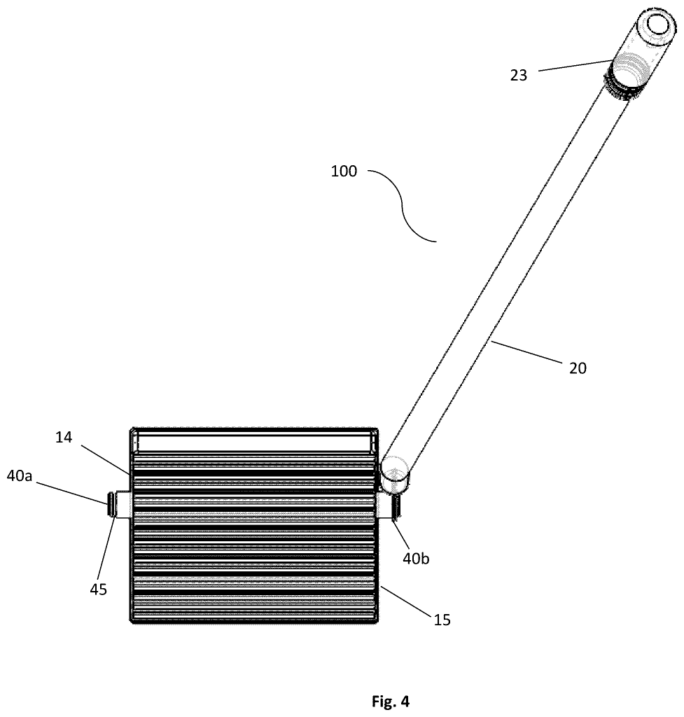

As shown in FIGS. 3-4, a first surface 11 can generally have a slope or angular orientation with respect to the ground or the third surface 13. In other exemplary embodiment, the first surface 11 and second surface 12 can have a generally planar surface or can have a convex or concave surface to better engage a wheel or tire. In some exemplary embodiments, the second surface 12 can be generally perpendicular to the third surface 13 to form a flat back portion of the chock portion 10. The chock portion 10 can have a first sidewall 14 and a second sidewall 15. One or more of the sidewalls 14,15 can have one or more engagement members 40. The engagement members 40 can take any suitable configuration. In some exemplary embodiments, the second end 22 of the handle portion 20 can have an angular portion 24 that extends slightly at an angle to be generally parallel to the sidewall and the remainder of the handle portion angled at a pre-determined angle between the remainder of the handle portion 20 and the sidewall. Alternatively, the angular portion 24 can be built into the coupling portion 30 or second end of the handle portion. The angular portion 24 can orient the handle portion at an angle away from the perpendicular sidewall as well as at an angle with respect to the ground surface as shown in FIG. 3. This can allow a user to more easily position the chock portion 10 into place under the wheel without requiring a user to navigate obstructions above the wheel such as a car or tractor trailer body as shown in FIG. 6D.

In one exemplary embodiment, the engagement members 40 can generally be a generally circular post member having a first diameter or width. Each post member 40 can have a first end 41 and a second end 42, wherein the post member 40 can extend generally perpendicular from the sidewall of the chock portion 10. A groove or channel 45 can be formed between the first end 41 and the second end of the post member 40. The groove 45 can engage with a coupling portion 30 that can be formed or coupled to the second end 22 of the handle portion 20. The coupling portion 30 can take any suitable configuration. The groove 45 can have a diameter/second diameter. The second diameter can be less than the first diameter of the post member 40. The coupling portion 30 can be planar in nature with one or more apertures 31 formed through each side of the coupling portion 30.

FIGS. 6A-6D illustrate an exemplary embodiment of a coupling portion 30 and engagement member 40. The aperture 31 can take any suitable configuration. In one exemplary embodiment, the aperture 31 of the coupling portion 30 can have a generally keyhole configuration with a first portion 32 of the aperture 31 having a diameter. The diameter of the first portion 32 can be greater than the diameter for the post member 40. The second portion 33 of the aperture 31 can have a second diameter. In some exemplary embodiments the second diameter can be less than the first diameter of the first portion 32 of the aperture 31. In other exemplary embodiments, the post member 40 can have a tip portion 44, a groove 45, and post portion 46 as shown in FIG. 6A. The tip portion can have a first diameter, the groove 45 can have a second diameter, and the post portion 46 can have a third diameter.

In some exemplary embodiments, the tip portion 44 diameter can be greater than the diameter of the groove portion 45, but less than the diameter of the post portion 46. The first portion 32 of the aperture 31 can have a diameter greater than the tip portion 44, but less than the post portion 46. The second portion 33 of the aperture 31 can have a diameter less than the tip portion 44 and post portion 46 but greater than the groove portion 45. This can allow the coupling portion 30 to slide into place on the engagement member 40 and removably couple the post portion 40. When the user lifts up the handle portion to move the chock portion 10, the second portion 33 can engage the groove and allow a user to move the chock portion 10 as shown in FIG. 6C.

A user can then slide the handle portion 20 downward toward the ground to disengage the groove 45 and remove the coupling portion 30 from the post member 40 through the first portion 32 of the aperture 31. This allows for fast and easy attachment and removal. The groove 45 can be configured or a stopping member can be provided a rotational stop of the handle portion 20 when the handle portion 20 is engaged with the chock portion 10. The groove portion 45 can be rectangular and not round to provide a stopping member.

The chock portion 10 can additionally have one or more reflective member 17 on one or more surfaces or sidewalls of the chock portion 10. The reflective member(s) 17 can reflect light to allow a user to easily identify the location of a chock portion 10. The first surface 11 of the chock portion 10 can have one or more raised grooves 16 to greater friction against a wheel. The reflective member can be reflective tape or high visibility tape, or any other suitable reflective material. In some exemplary embodiments, the reflective can be reflective member 17 can be located at a bottom surface of the wedge and at the side surfaces of the wedge.

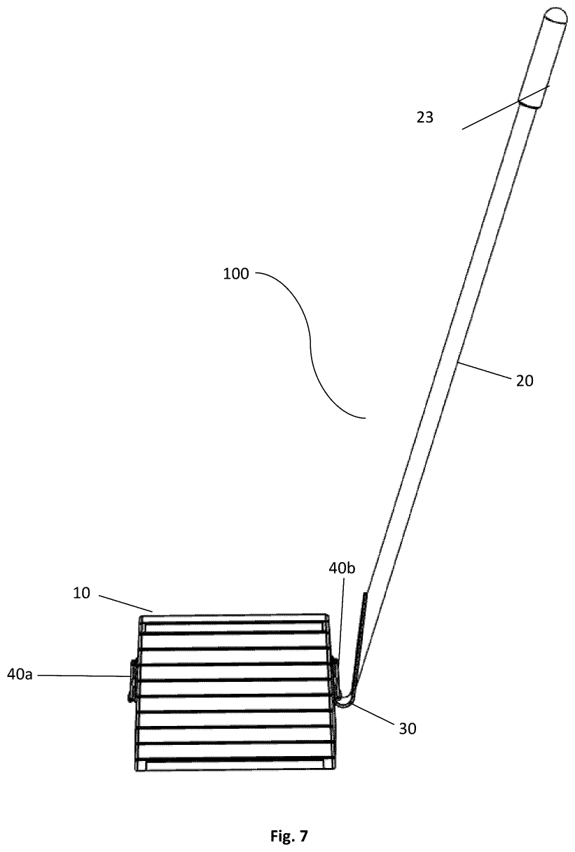

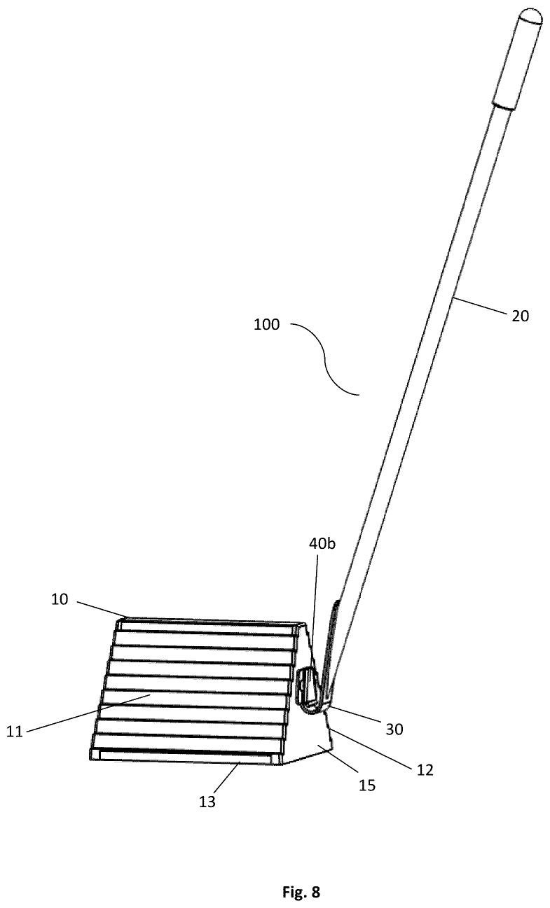

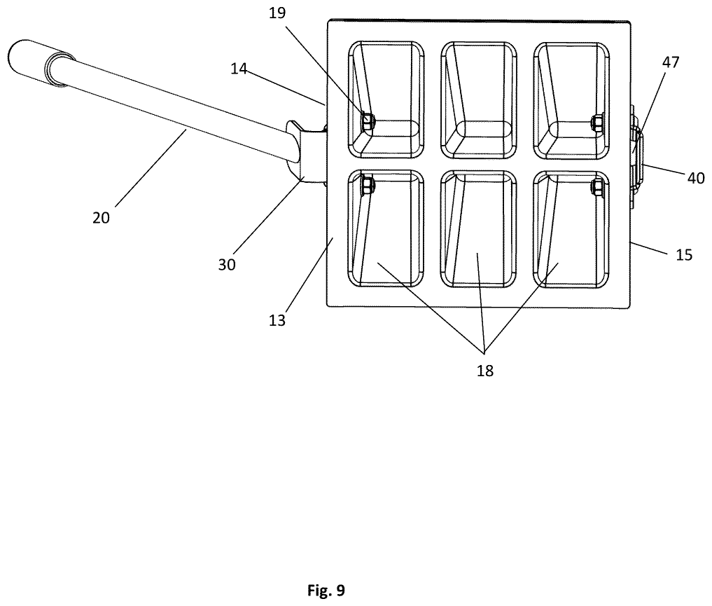

As shown in FIGS. 7-11, exemplary embodiments of the wheel chock apparatus 100 of the present disclosure can include a chock portion 10 that have two angular surfaces 11, 12 that can allow a user to interchangeably use each of the first surface 11 and second surface 12 to interface with a wheel or tire. The first and second surfaces can generally be surfaces to contact the tire or wheel portion of a vehicle or trailer. The wheel contact surfaces can be angular and planar like a wedge or alternatively have a curve to contour to the shape of a wheel. In some exemplary embodiments, only one of the surfaces may be configured to contact a wheel 200, whereas in other embodiments both surfaces can be configured to contact a wheel. Additionally, the chock portion 10 can be placed between two tandem wheels or double axel wheels to provide an interfacing means with the tire to prevent it from moving.

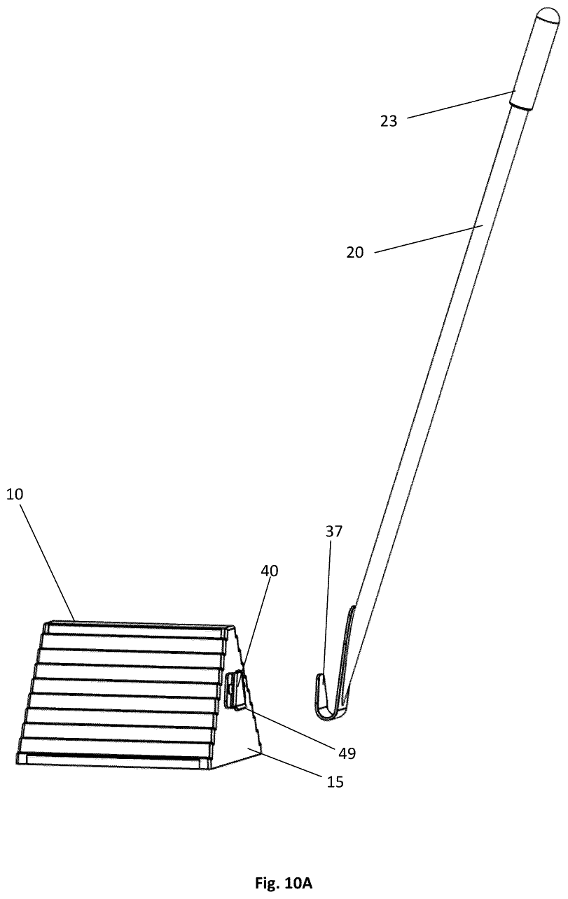

The wheel chock apparatus 100 can have similar structure with a slightly different configuration of the engagement member(s) 40 and the connection portion 30 of the handle portion 20. Additionally, in some exemplary embodiments, the interior of the chock portion 10 can be partially hollow. One or more cavities 18 can be formed into the body of the chock portion from the bottom surface 13 as shown in FIG. 9. The one or more cavities 18 can reduce the weight and material needed for the chock portions 10.

Additionally, the interior cavity can provide access to a coupling means 19 for attaching the engagement members to the sidewall(s) 14,15 of the chock portion 10. In some exemplary embodiments, the coupling means 19 can be a fastener, such as a nut and bolt, screw, nail, rivet or any other suitable coupling means. The removable coupling means 19 can allow a user to switch out engagement members 40 if they become damaged without having to completely dispose of the whole chock portion 10.

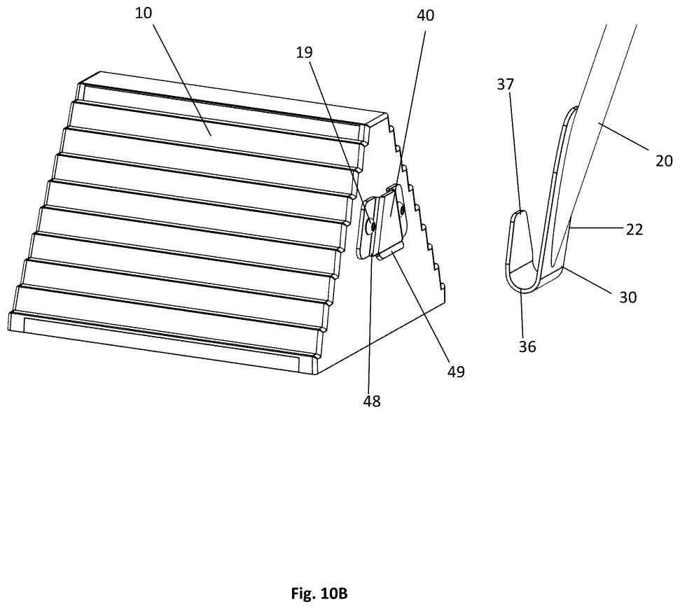

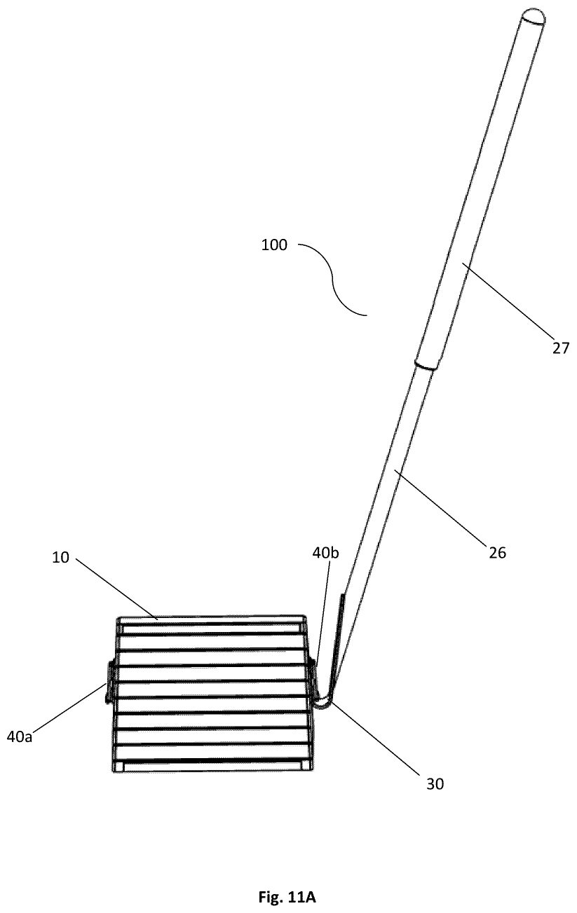

As shown in FIGS. 10A-10B, a coupling portion 30 can include a curved member 37. The curved portion 36 can extend down generally from the second end 22 of the handle portion 20 and extend up to form the curved member 37. The curved member 37 can have a generally triangular or wedge shape as shown in FIG. 10B, however, it should be understood that any suitable configuration can be used. The curved member 37 can be configured to removably couple to the engagement member 40. The engagement member 40 can have an interior opening 47 with a shape that approximates the shape of the curved member 37. By having the interior opening 47 and curved member 37 shapes generally correspond, the chock portion 10 can be limited from rotation movement when it is lifted off the ground. A user can position the curved member 37 under the interior opening 47 of the engagement members and lift up to engage the engagement member 40 and move the chock portion 10. The user can then sit the chock portion 10 down and press down on the handle portion 20 to disengage the handle portion 20 from the chock portion 10.

The engagement member 40 can additionally have an angular portion 49 extending from the bottom edge 48 of the engagement member. The angular portion 49 can form a lip to better guide the curved member 37 into the opening 47 of the engagement member. The engagement member can have an interior surface of the opening and an exterior surface. The front wall of the engagement member can have a surface forming the exterior surface and a portion of the interior surface. The angular guide portion 49 can be formed on the sidewall of the engagement member 40 to better guide the curved member 37 into the opening. Similarly, the interior surface can be beveled or round to further aid in guiding the curved member into the opening 47. The tip of the curved member 37 can similarly be rounded to prevent it from poking the user or getting caught on other objects as well as guide the curved member 37 into the opening 47.

The interior opening 47 can have a greater width at the bottom edge and a smaller width at the top edge of the opening. Similarly, the curved member 37 can have a greater width at the bottom portion of the curved member 37 and a narrower width at the top of the curved member 37. The dimensions of the curved member 37 can generally be generally equal to or slightly less than the dimensions of the opening 47 to allow the curved member to fit within the opening 47.

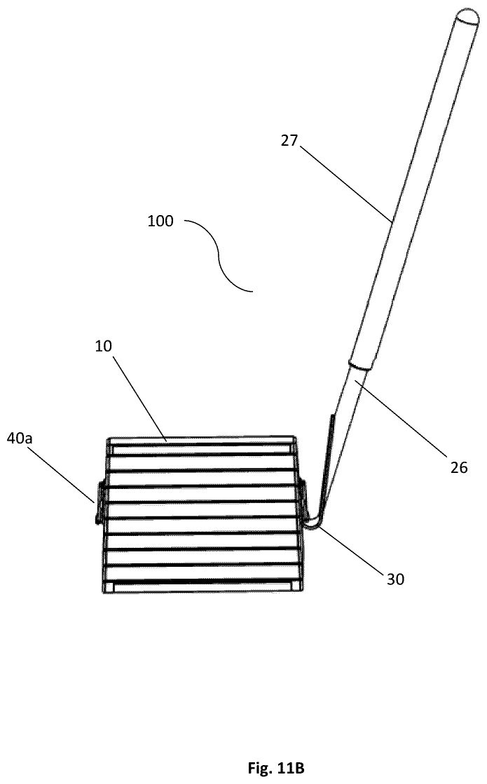

As shown in FIGS. 11A-11B, the handle portion 30 can be adjustable, collapsible or capable of being folded or broken down into separate smaller components. In some exemplary embodiments, the handle portion 20 can be telescopic having a first portion 26 and a second portion 27. The first portion 26 can have a smaller diameter than the second portion 27. The second portion 27 can have a hollow interior diameter greater than the exterior diameter of the first portion 26 to allow the second portion to be at least partially housed within the second portion 27. In other embodiments, the handle portion can have one or more folding points to reduce the size of the handle portion for easy storage. In other exemplary embodiments, the angular

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A wheel chock apparatus, comprising:
a chock portion having a first surface, second surface, and a third, a first sidewall and a second sidewall, wherein an engagement member can be coupled to the first sidewall; and
a removably couple handle portion, wherein the handle portion includes a first end and a second end, wherein the second end includes a coupling portion, wherein the coupling portion is configured to removably couple to the engagement member on the chock portion.

2. The wheel chock apparatus of claim 1, wherein the handle portion further includes a grip.

3. The wheel chock apparatus of claim 2, wherein the first surface is angular and the second surface and third surface are perpendicular to each other.

4. The wheel chock apparatus of claim 3, wherein the first surface has a curvature.

5. The wheel chock apparatus of claim 1, wherein the first surface and second surface are angular to each other and with respect to the third surface.

6. The wheel chock apparatus of claim 1, wherein the engagement member includes a post member having a tip portion having a first diameter, groove portion having a second diameter, and post portion having a third diameter, wherein the first diameter is greater than the second diameter, and the third diameter is greater than the first diameter.

7. The wheel chock apparatus of claim 6, wherein the coupling member includes an aperture having a first portion with a diameter and a second portion with a diameter, wherein the diameter of the first portion is greater than the diameter of the first diameter of the tip portion and less than the third diameter of the post portion.

8. The wheel chock apparatus of claim 7, wherein the second portion of the aperture has a diameter greater the second diameter of the groove portion but less than the diameter of the tip portion.

9. The wheel chock apparatus of claim 8, wherein the third surface of the chock portion has one or more cavities.

10. The wheel chock apparatus of claim 9, further comprising a second engagement member coupled to the second sidewall.

11. The wheel chock apparatus of claim 10, further comprising a reflective member coupled to one or more of the first surface, second surface, third surface, first sidewall, or second sidewall of the chock portion.

12. The wheel chock apparatus of claim 1, wherein the first engagement member and second engagement member are configured to interface with the coupling portion of the handle portion.

13. The wheel shock apparatus of claim 12, wherein the engagement member has top edge and a bottom edge, with an opening formed therethrough, wherein the bottom edge of the opening has a first width and the top edge of the opening has a second width.

14. The wheel chock apparatus of claim 13, wherein the first width is greater than the second width.

15. The wheel chock apparatus of claim 14, wherein the coupling portion includes a curved member configured to fit within the engagement member.

16. The wheel chock apparatus of claim 15, wherein the bottom portion of the curved member has first width equal to or less than the first width of the bottom edge of the opening of the engagement member.

17. The wheel chock apparatus of claim 16, wherein the top portion of the curved member has a width less than or equal to the top edge of the opening of the engagement member.

18. The wheel chock apparatus of claim 17, wherein the bottom edge further comprises an angular guide portion.

19. The wheel chock apparatus of claim 18, wherein the handle portion is oriented generally at an angle with respect to the first sidewall or second sidewall the handle portion is coupled.
